(19) United States
(12) Patent Application Publication
(10) Pub. No.: US 2002/0140990 A1
(43) Pub. Date: Oct. 3, 2002

(54) Focus calibrating method for image scanning device by testing focus chart

(76) Inventor: Rong-Ji Liu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/817,284

(22) Filed: Mar. 27, 2001

(51) Int. Cl. H04N 1/04; H04N 1/047; G02B 7/04

(52) U.S. Cl. 358/406; 358/474; 250/201.2

(57) ABSTRACT

A focus calibrating method for an image scanning device by testing a focus chart is disclosed. The focus chart has a base sheet and a plurality of black bars with different widths arranged in parallel on the base sheet and spaced from each others. The focus chart is adhered on a bottom surface of a top panel supporting the document positioning plate of the scanner and disposed facing the optical scanning module of the scanner. The focus method includes steps of moving the optical scanning module to read the image data of the focus chart, calculating a focal length value of the image data of the focus chart, judging whether a predetermined optimal focal length is reached or not according to the calculated focal length value, repeatedly moving the optical scanning module with respect to the focus chart to adjust the focal length until the optimal focal length is reached. The focus method further includes a step of setting a preset scanning resolution for selecting a specific black bar during testing the focus chart.

### BACKGROUND OF THE INVENTION

1. Field of the Invention

The present invention relates to a focus calibrating method for image scanning device, and more specifically to a focus calibrating method by testing a focus chart. The focus chart has a base sheet and a plurality of black bars with different widths arranged in parallel on the base sheet and spaced from each others.

2. Description of the Prior Art

Scanners have been widely utilized in scanning images to allow retrieving and saving. Due to improvements in the scanning technology and the demands for scanning high quality images, the scanning resolution of the scanner becomes higher and higher. Therefore, the subject matter of focusing during scanning operation is an important issue.

FIG. 1 of the attached drawings shows an example of a conventional flat-bed optic scanner, mainly comprising a casing 1, a top panel 11, a light transmittable document positioning plate 12, a cover 13, an optical scanning module 14, and a pair of guide rods 15a, 15b.

The document positioning plate 12 is generally made of glass or other light transmittable material for supporting a document to be scanned (not shown), defining a document scanning widow of the scanner. The cover 13 is pivotally mounted on a lateral side of the casing 1, serving as a light masking plate.

The guide rods 15a, 15b are parallel to and spaced from each others. The optical scanning module 14 may be moved along the guide rods 15a, 15b in a direction I by a driving mechanism (not shown), starting from an initial scanning side 10 of the scanner. The driving mechanism generally includes a driving motor and a transmission belt or a gear train mechanically coupled to the optical scanning module.

Referring to FIG. 2, it is a schematic view showing the optical path of the conventional scanning device of FIG. 1. The optical scanning module 14 is provided with a light source 16, a plurality of reflective mirrors 171, 172, 173, 174, a focusing lens 18, and an image sensing module 19 such as a Charge Coupling Device (CCD).

Before the scanner performs a formal scanning to the document 2 properly located on the document positioning plate 12, a calibration procedure may be employed. The conventional calibration procedure includes a focus testing procedure. In order to execute the focus calibrating procedure, a calibration area is defined at the initial scanning side 10 of the document positioning plate 12. Beside, a focus chart 3 is adhered to the bottom surface of the top panel 11 adjacent to the initial scanning side 10 and is disposed facing the optical scanning module 14.

The focus chart 3 employed in prior art comprises a number of white areas 31 and a black area 32, as shown in FIG. 2. Each of the white areas 31 is spaced from each others and has a fixed width. Various prior art focus testing methods are developed by using the focus chart 3.

In order to obtain a clear scanned image, a better focusing function is required. However, in actual practice, the user of the optical scanner may require different canning resolutions for different purposes. For example, the user may use a scanning resolution of 300 dpi to scan a regular image, or a scanning resolution of 1200 dpi to scan a fine picture. When performing a focus calibration procedure by testing the focus chart in different resolution requirements, it is difficult to reach a high performance by considering both focus calibrating speed and high scanning resolution.

It is thus desirable to provide a focus calibrating method for the image scanning device to overcome the above problems.

### SUMMARY OF THE INVENTION

The primary object of the present invention is to provide a focus calibrating method for an optical scanner by testing a focus chart, prior to a formal scanning procedure to a document to be scanned.

The other object of the present invention is to provide a focus chart testing method for an optical scanner. The focus chart has a base sheet and a plurality of black bars with different widths arranged in parallel on the base sheet and spaced from each others. The focus chart is adhered on a bottom surface of a top panel supporting the document positioning plate of the scanner and disposed facing the optical scanning module of the scanner.

The other object of the present invention is to provide a focus chart testing method for an optical scanner with selectable preset scanning resolutions. The user can set a preset scanning resolution, and then the present invention will perform a series of calibration procedures based on the preset scanning resolution.

To achieve the above objects, in accordance with a preferable embodiment of the present invention, there is provided a focus calibrating method for an image scanning device by testing a focus chart. The focus calibrating method includes steps of moving the optical scanning module to read the image data of the focus chart, calculating a focal length value of the image data of the focus chart, judging whether a predetermined optimal focal length is reached or not according to the calculated focal length value, repeatedly moving the optical scanning module with respect to the focus chart to adjust the focal length until the optimal focal length is reached. Preferably, the focus method further includes a step of setting a preset scanning resolution for selecting a specific black bar during testing the focus chart.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a conventional flat-bed image scanning device;

FIG. 2 is a schematic view showing the optical path of the conventional image scanning device of FIG. 1;

FIG. 3 illustrates a pattern of a focus chart of the prior art;

FIG. 4 illustrates a pattern of a focus chart in accordance with the present invention;

FIG. 5 is a schematic view showing the optical path of the image scanning device in accordance with the present invention;

FIG. 6 is a control flow chart of the focus calibrating method according to a first embodiment of the present invention; and

FIG. 7 is a control flow chart of the focus calibrating method according to a second embodiment of the present invention.

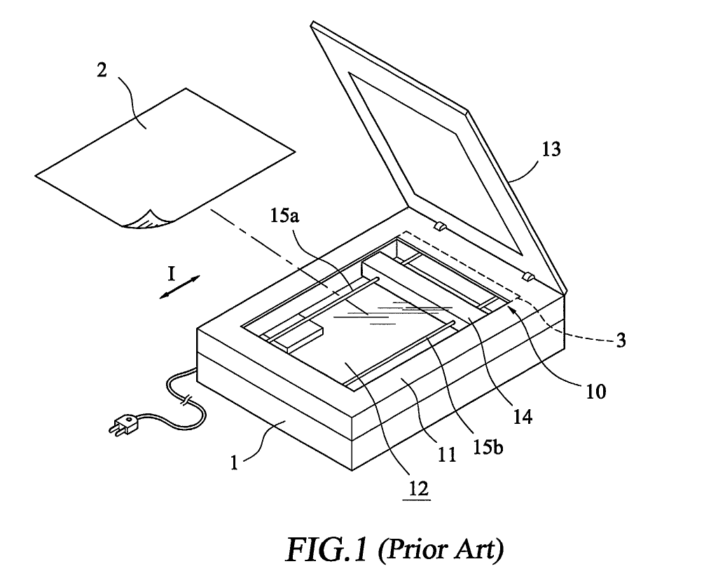

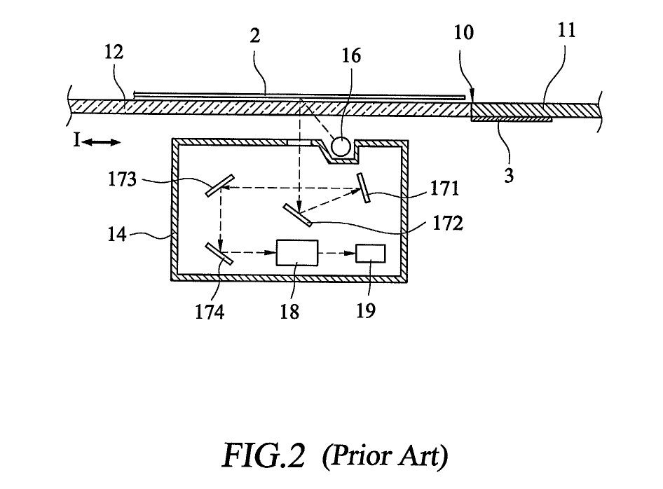

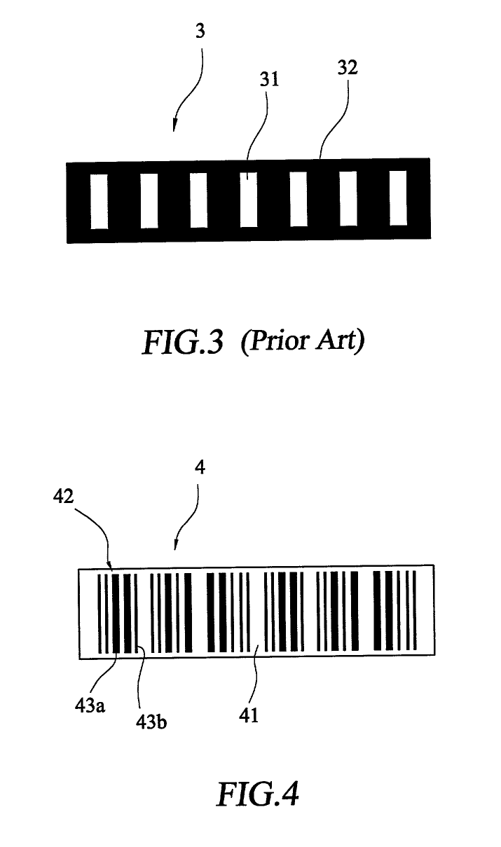

### DETAILED DESCRIPTION OF THE PREFERRED EMBODIMENTS

Referring to FIG. 4, it illustrates a pattern of a focus chart in accordance with a preferred embodiment of the present invention. The focus chart 4 comprises a base sheet 41, and a number of black bars 42 arranged in parallel and spaced from each others on the base sheet 41. Each of the black bars 42 further comprises a number of wider black bars 43a and narrower black bars 43b of different widths.

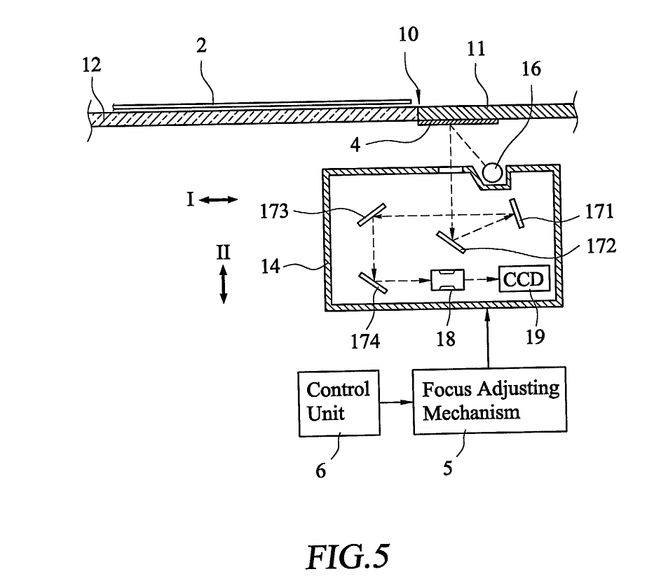

With reference to FIG. 5, it is a schematic view showing an optical path of a reflective type image scanning device in accordance with the present invention. The same reference numbers used in the previous drawing will be used to refer to the same or like parts.

A document 2 to be scanned is placed on a document positioning plate 12 of an image scanning device. The document positioning plate 12 is supported by a top panel 11 of the scanner. An optical scanning module 14 is arranged beneath the document positioning plate 12, which is equipped with a light source 16, a plurality of reflective mirrors 171, 172, 173, and 174, a focusing lens 18, and an image sensing module 19. The optical scanning module 14 may be moved by a known driving mechanism (not shown) in a first direction I to scan the document 2 placed on the document positioning plate 12. The first direction I is substantially parallel to the document positioning plate 12 and the movement of the optical scanning module 14.

The focus chart 4 as shown in FIG. 4 is adhered to the bottom surface of the top panel 11 at the initial scanning side 10 of the document positioning plate 12. The extending direction of the black bars 42 is same as the first direction I of the movement of the optical scanning module 14.

A focus adjusting mechanism 5 is capable of moving the optical scanning module 14 in a second direction II substantially perpendicular to the document positioning plate 12 under control of a control unit 6.

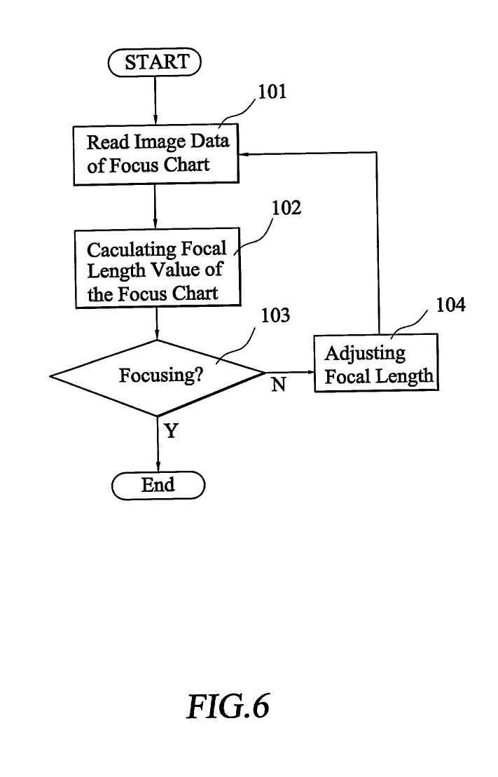

With reference to FIGS. 5 and 6, the focusing method of the present invention will be described in more detail below. FIG. 6 shows a control flow chart according to a first embodiment of the present invention. Before scanning the document, the optical scanning module 14 is controlled to scan the focus chart 4 adhered on the bottom surface of the top panel 11. Initially, in step 101, the optical scanning module of the scanner reads the image data of the focus chart 4 by scanning the focus chart 4. Then, the control unit of the scanner calculates the focal length value of the image data of the focus chart 4 in step 102.

In step 103, the control unit judges whether the focusing to the focus chart 4 has been reached by means of the application of, for example, a known approached recognition method. The focus testing procedure will be finished if the focusing has been reached. If the focusing has not been reached yet, the control unit will repeatedly drive the optical scanning module 14 in step 104 to move in the second direction II to adjust the focal length with respect to the focus chart 4, and finally an optimal focal length may be obtained. After the focus testing procedure has been completed, the scanner will perform a formal scanning procedure to scan the document 2 located on the document positioning plate 12.

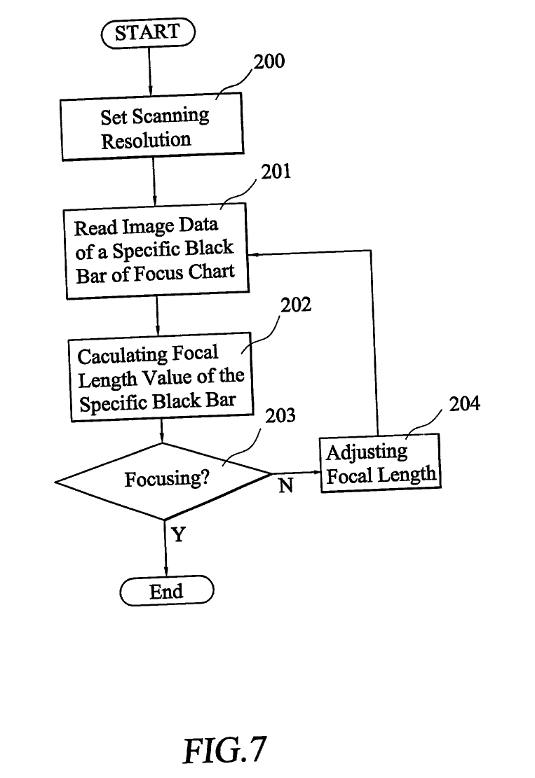

FIG. 7 is a control flow chart according to a second embodiment of the present invention. This alternative embodiment enables the user to set a desired scanning resolution for the scanner. After the user sets the desired scanning resolution in step 200, the control unit 6 of the scanner automatically selects one specific black bar 42 arranged on the base sheet 41 of the focus chart 4 according to the set scanning resolution for focus testing.

For example, for a low-resolution requirement, the scanner operated in low resolution scanning mode needs only to scan the black bar 42 of relatively broader width. On the contrary, for a high-resolution requirement, the scanner operated in high resolution scanning mode needs only to scan the black bar 42 of relatively narrower width. Normally, the scanner takes a longer time to scan the black bar in high resolution scanning mode than in high resolution scanning mode.

After the setting of the scanning resolution, the optical scanning module of the scanner reads the image data of the specific black bar 42 of the focus chart 4 in step 201 by scanning the focus chart 4. Then, the control unit of the scanner calculates the focal length value of the image data of the specific black bar of the focus chart 4 in step 202.

In step 203, the control unit judges whether the focusing to the specific black bar 42 of the focus chart 4 has been reached. The focus testing procedure will be finished if the focusing has been reached. If the focusing has not been reached yet, the control unit will repeatedly control the optical scanning module 14 in step 204 to move in the second direction II to adjust the focal length with respect to the focus chart 4, and finally an optimal focal length value may be obtained. After the focus testing procedure has been completed, the scanner will perform a formal scanning procedure to scan the document 2 located on the document positioning plate 12.

Although the present invention has been described with reference to the preferred embodiments thereof, it is apparent to those skilled in the art that a variety of modifications and changes may be made without departing from the scope of the present invention which is intended to be defined by the appended claims.

1. A focus calibrating method for an image scanning device provided with an optical scanning module, a document being located on a document positioning plate of the image scanning device, comprising the following steps:
(a) preparing a focus chart having a base sheet and a plurality of black bars with different widths arranged in parallel on the base sheet and spaced from each others;
(b) moving the optical scanning module to read the image data of the focus chart in a first direction;
(c) calculating a focal length value of the image data of the focus chart;
(d) judging whether a predetermined optimal focal length is reached or not according to the calculated focal length value, and, if not, repeatedly moving the optical scanning module in a second direction perpendicular to the first direction to adjust the focal length with respect to the focus chart until the optimal focal length is reached; and
(e) driving the optical scanning module to scan the document based on the optimal focal length.

2. The focus calibrating method as claimed in claim 1, wherein the black bars arranged on the base sheet are extended in a direction same to the first direction.

3. The focus calibrating method as claimed in claim 1, wherein the focus chart is adhered on a bottom surface of a top panel supporting the document positioning plate of the scanner and disposed facing the optical scanning module.

4. A focus calibrating method for an image scanning device provided with an optical scanning module, a document being located on a document positioning plate of the image scanning device, comprising the following steps:
(a) preparing a focus chart having a base sheet and a plurality of black bars with different widths arranged in parallel on the base sheet and spaced from each others;
(b) setting a preset scanning resolution;
(c) selecting a specific black bar according to the preset scanning resolution;
(d) moving the optical scanning module to read the image data of the specific black bar of the focus chart in a first direction;
(e) calculating a focal length value of the specific black bar of the image data of the focus chart;
(f) judging whether a predetermined optimal focal length is reached or not according to the calculated focal length value, and, if not, repeatedly moving the optical scanning module in a second direction perpendicular to the first direction to adjust the focal length with respect to the specific black bar of the focus chart until the optimal focal length is reached; and
(g) driving the optical scanning module to scan the document based on the preset scanning resolution and the optimal focal length.

5. The focus calibrating method as claimed in claim 4, wherein the black bars arranged on the base sheet are extended in a direction same to the first direction.

6. The focus calibrating method as claimed in claim 4, wherein the focus chart is adhered on a bottom surface of a top panel supporting the document positioning plate of the scanner and disposed facing the optical scanning module.
